(19) United States
(12) Patent Application Publication
(10) Pub. No.: US 2017/0148235 A1
(43) Pub. Date: May 25, 2017

(54) VEHICLE DAMAGE DETECTION AND NOTIFICATION SYSTEM

(71) Applicant: Continental Automotive Systems, Inc., Auburn Hills, MI (US)

(72) Inventors: Mohammed Kazim Yakub, Rochester Hills, MI (US); Ryan David Duprey, Rochester Hills, MI (US)

(21) Appl. No.: 14/945,775

(22) Filed: Nov. 19, 2015

(51) Int. Cl. G07C 5/08; G07C 5/00

(52) U.S. Cl. CPC G07C 5/0816; G07C 5/008; G07C 5/0808; G07C 5/085

(57) ABSTRACT

A disclosed damage detection and notification system for a motor vehicle notifies and alerts a driver of damage to a vehicle and gathers data indicative of the amount and cause of damage to the vehicle.

### TECHNICAL FIELD

The present disclosure relates to a system for detecting vehicle damage and notifying a vehicle operator of the damage.

### BACKGROUND

Modern motor vehicles include sophisticated sensors that provide information about all aspects of vehicle operation as well as the environment surrounding the vehicle. A vehicle is often left unattended remote from the vehicle operator. When a vehicle is not operating, many of the sensors are not operating and not gathering data. Moreover, when a vehicle is parked and the operator is not present, it can be difficult if not impossible to determine the cause and responsible party for damage done to a vehicle. In such instances, the vehicle operator will have no information as to how the damage was done to the vehicle and who is responsible. Accordingly, it is desirable to develop a system that alerts a vehicle operator of vehicle damage and gathers data indicative of the cause and extend of damage.

### SUMMARY

A disclosed example embodiment of a damage detection and notification system includes sensors disposed within the vehicle to detect impacts and/or other damage to the vehicle and cameras to capture images of the environment surrounding the vehicle. The example sensors are capable of detecting localized accelerations such as may be caused by an impact with another object such as a shopping cart or another vehicle. Each of the sensors and cameras communicate with a controller. The controller includes a transmitter for transmitting an alert and notification to a user indicative of damage to the vehicle. The alert notifies of the damage and also to a severity of the damage to the vehicle. Moreover, data from the vehicle including images of the environment around the vehicle can be transmitted to the operator remote from the vehicle to provide an indication of the severity and potential cause of the damage.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic representation of a vehicle including an example damage detection and driver notification system.

FIG. 2 is a schematic representation of a controller of the example damage detection and driver notification system.

### DETAILED DESCRIPTION

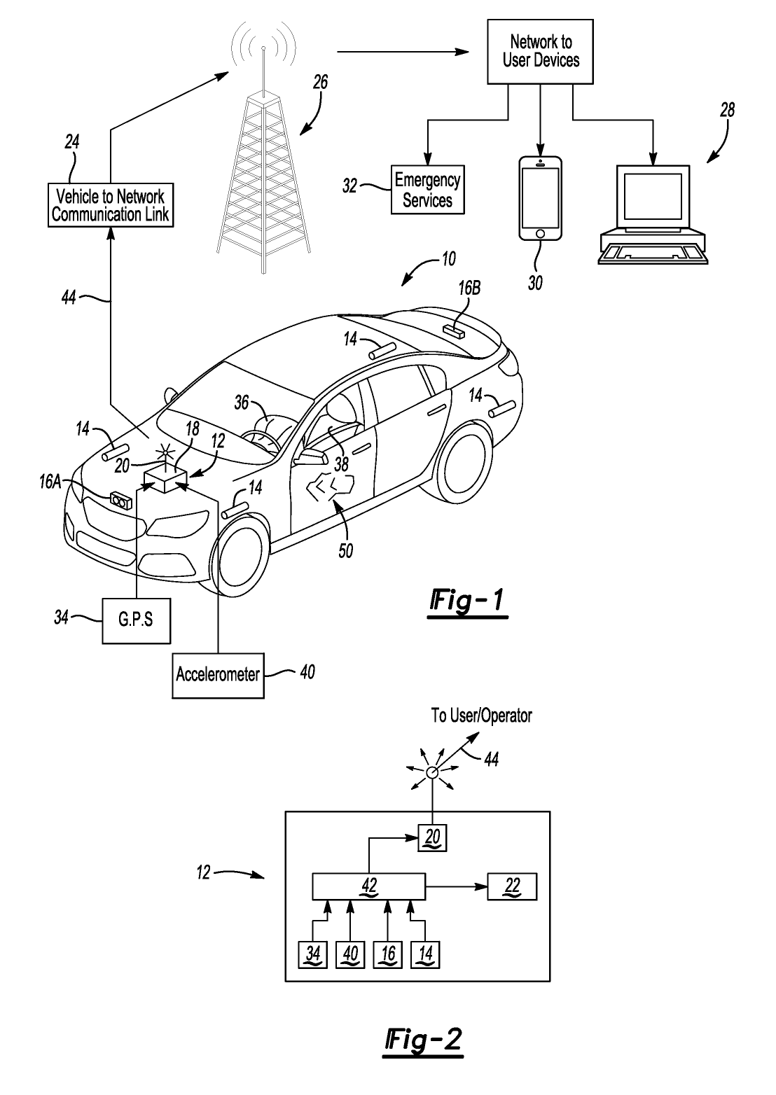

Referring to FIG. 1, a vehicle 10 includes a vehicle damage detection and notification system 12 that utilizes sensors 14 within the vehicle to detect damage and notify a vehicle operator of damage to the vehicle 10.

Many motor vehicles include alarm systems that emit an audible alarm upon the attempted theft of a vehicle. The audible alarm alerts those proximate the vehicle of the attempt theft. However, a vehicle operator not close to the vehicle may not hear the alarm and therefore not know immediately of the attempted theft. Moreover, even if the operator is alerted to the attempted theft, such notifications are not useful in determining the cause or extent of damage. The disclosed example damage detection and notification system 12 notifies a driver of damage to a vehicle and gathers data indicative of the amount and cause of damage to the vehicle.

The example vehicle 10 includes the damage detection and notification system 12 that utilizes sensors 14 disposed within the vehicle. The sensors 14 are utilized to detect impacts and/or other damage to the vehicle 10. The example sensors 14 are capable of detecting localized accelerations such as may be caused by an impact with another object such as a shopping cart or another vehicle.

The example vehicle 10 includes several sensors 14 disposed at different locations around the vehicle 10. The sensors 14 provide feedback of current vehicle operating conditions including a speed of the vehicle. Each of the example sensors 14 communicate with a controller 18. The controller 18 receives signals from the sensors 14 and processes the incoming signals to determine if the data communicated is indicative of damage to the vehicle. If the controller 18 determines that such data is indicative of damage to the vehicle, the controller 18 will analyze the information to determine a degree of severity of damage to the vehicle.

The example vehicle 10 also includes forward facing camera 16A and an aft facing camera 16B for capturing images of objects and the environment surrounding the motor vehicle 10. Although, the disclosed example includes the forward facing camera 16A and an aft facing camera 16B, other camera locations may be utilized included with the vehicle 10 and are within the contemplation of this disclosure.

The example vehicle 10 also includes a global positioning system (GPS) 34 and an accelerometer 40 that communicate information to the controller 18. The GPS 34 provides information indicative of the vehicle location and the accelerometer provides information indicative of a speed of the vehicle 10. The accelerometer 40 may also provide information indicative of a force of impact on the vehicle 10.

The vehicle 10 includes occupant safety devices such as an airbag 36 and seat belt system 38. In one example, the seat belt system 38 is an active system that actuates in response to signals from the various sensors 14, 40 and the cameras 16A, 16B indicative of an impending impact. The active seat belt system 38 can aid in restraining an occupant in a proper position within the cabin of the vehicle to optimize protection.

Referring to FIG. 2, with continued attention to FIG. 1, the example controller 18 includes a module 42 that receives information from the various sensors 14, 40 cameras 16A-B and the GPS 34 system. The module 42 monitors the incoming information and performs an analysis to recognize if the vehicle has been impacted or damaged in some way. The analysis is performed by a program implemented as software that receives signals from each of the sensors 14, 40 and cameras 16A-B and determines if the information provided is indicative of damage to the vehicle 10.

As appreciated, although the example damage detection and driver notification system 12 operates when a vehicle is parked, it is also within the contemplation of this disclosure that the system 12 is operational during normal driving operation of the vehicle 10.

In response to the module 42 generating a conclusion that the vehicle is involved in a damage incident, the controller 18 will operate to automatically send a signal 44. The controller 18 includes a transceiver 20 that can both send and receive cellular network signals such to a cell network 26. The transceiver 20 may also include provisions to send other signal formats for communicating to a user or driver of the vehicle. A storage module 22 is included for storing information from the sensors 14, 40 and cameras 16A, 16B to preserve information concerning damage to the vehicle 10.

In operation, when a vehicle operator leaves a vehicle, the vehicle remains stationary and is left in the standard off condition. The example system 12 engages in response to detection of a damage or accident condition. In this example, the vehicle is parked and damage occurs through an impact on the driver side door as is schematically shown at 50. Upon detection of the impact, the sensors 14, 40 mounted throughout the vehicle 10 are utilized to detect the damage. Damage to the vehicle 10 can be through the use of the accelerometer sensor 40 that detect and measure vibrations indicative of the impact. The sensors 14, 40 may also detect acceleration of the vehicle along with the vibrations and generate a signal indicative of damage to the vehicle 10.

Once the system 12 detects that the vehicle 10 has been damaged, data is recorded to capture information relating to the current vehicle condition. As appreciated in the park condition, the data will include coordinate data from the GPS 34 so that the position of the vehicle can be determined as well as data that is indicative of the amount of damage done to the vehicle. As appreciated, the higher the vibration or impact measured by the sensors 14, 40, the greater the likely damage to the vehicle.

The example system 12 actuates the front and aft cameras 16A-B to capture images of the environment surrounding the vehicle. These images are useful in determining the cause of the accident or damage to the vehicle. For example, if the vehicle is hit while parked, the cameras can capture images of the cars, objects and people surrounding the vehicle to aid in determining the cause of damage. The images captured by the cameras 16A-B are stored in the storage module 22 and can be later utilized to prove damage and potentially verify the source of the damage to the vehicle. All the information regarding the condition of the vehicle at the time of damage is stored in the module 22 for later collection and analysis to determine the cause of damage.

Storage of data within the storage module 22 within the vehicle is useful, but does not provide the user with information until at the vehicle. Moreover, severe damage may result in a loss of some of this data. Accordingly, the example system 12 generates a signal 44 that is sent to a place designated by the vehicle operator. In this example, the signal 44 is sent to user devices such as a desktop computer 28 and mobile device 30. The signal 44 may also be sent to emergency services 32 if the damage is indicative of potential injury. The example signal 44 is transmitted through a vehicle network 24 to a cell network 26 and finally to the user designated devices 28, 30. The signal 44 may be sent to the user in many forms including email, text, voice messages or other communication format intended to alert the driver of the condition of the vehicle 10.

The example signal 44 will include an alert to the vehicle user indicating that the vehicle 10 has been damaged. The signal 44 can include information providing only a simple alert that some damage has occurred, a summary of the damage, images, or a complete set of data gathered responsive to damage to the vehicle. The communication of the data from the vehicle informs the user of the damage and also provides for preservation of data about the cause of the vehicle damage. As appreciated, if the vehicle is completely destroyed, the data from the storage module 22 will be lost. The example system 12 provides for transmission of the signal 44 including data on the damage done to the vehicle. This data can be stored in the user devices 28, 30 for later retrieval to aid in determined a cause of the damage.

Moreover, the immediate transmission of the data signal 44 provides the driver with a means of determining what actions should be taken. For example, of only minor damage is detected and the images from the cameras 16A-B indicate that perhaps a shopping cart has bumped the vehicle, a driver will know that immediate action is not required. In contrast, if the signal indicates that a window has been broken out and the cameras 16A-B show images of a person entering the vehicle, the user will know to alert the proper authorities promptly.

Moreover, the system may operate while the user is operating the vehicle and send the signal to the emergency services 32. Data indicative of the crash can alert emergency service personal of the severity of the crash while in route to the scene of an accident. Moreover, the various cameras 16A-B can provide information on the number and severity of any injury to those involved in an accident so a proper emergency response can be quickly dispatched.

Accordingly, an example operation of the system 12 can be described as beginning with the vehicle 10 in a parked condition. The sensors 14, 40 throughout the vehicle monitor the current vehicle condition. Upon the measurement of a condition that is indicative of damage to the vehicle, the damage detection and driver notification system 12 gathers and stores data from the various sensors 14,40 as well as the cameras 16A-B throughout the car to obtain measured data about the vehicles condition.

The cameras 16A-B mounted within the vehicle 10 capture images of the environment surrounding the vehicle 10. The data captured regarding the vehicle conditions and the environment surrounding the vehicle will be stored in the storage module 22 for later use and to generate a complete record of the vehicle condition and the environment surrounding the vehicle.

Additionally, upon actuation of the sensors to gather data, the controller 18 will send the signal 44 through the cellular network 26 corresponding with the vehicle to the user designated devices 28, 30 to alert the driver. The signal 44 can be sent through the vehicles mobile communication device 24 or through another wireless communication device located within the vehicle an automatically actuated independent of operator action.

The data that is sent through the cellular network 26 to the vehicle operator or the computer system is stored to preserve this data independent of the vehicle. Storage independent of the vehicle may be valuable in determining the source and cause of damage to the vehicle. Accordingly, by maintaining a record of the information outside of the vehicle, potential catastrophic damage to the vehicle will not result in loss of the measured and obtained information.

Accordingly, the example damage detection and notification system 12 obtains as much information as possible regarding the vehicle and the surrounding environment in response to any damage detection. The information is transmitted to locations remote from the vehicle and to the vehicle operator and other systems to both preserve and notify of damage to the vehicle.

Although an example embodiment has been disclosed, a worker of ordinary skill in this art would recognize that certain modifications would come within the scope of this disclosure. For that reason, the following claims should be studied to determine the scope and content of this disclosure.

What is claimed is:

1. A vehicle damage detection system comprising:
at least one sensor mounted within the vehicle for detecting information indicative of damage to the vehicle;
a recording device mounted within the vehicle engaged responsive to the at least one sensor indicating damage to the vehicle; and
a controller generating and sending a signal alerting a vehicle operator of the damage to the vehicle.

2. The vehicle damage detection system as recited in claim 1, wherein the recording device comprises a camera mounted with in the vehicle that captures images of an environment surrounding the vehicle responsive to detection of damage to the vehicle.

3. The vehicle damage detection system as recited in claim 1, wherein the at least one sensor comprises an accelerometer detecting an impact to the vehicle.

4. The vehicle damage detection system as recited in claim 1, wherein the controller includes a database that stores vehicle operating information for a defined time responsive to detection of damage to the vehicle.

5. The vehicle damage detection system as recited in claim 4, wherein the vehicle operating information comprises at least one of a gps coordinate, time, date, accelerometer reading, and vehicle speed.

6. The vehicle damage detection system as recited in claim 1, wherein the controller includes a transmitter capable of transmitting a signal to the vehicle operator over a cellular network.

7. The vehicle damage detection system as recited in claim 1, wherein the signal from the controller includes information indicative of the damage to the vehicle.

8. The vehicle damage detection system as recited in claim 7, wherein the signal comprises one of an email, a text message and a wireless signal to a network.

9. A method of communicating vehicle condition to a vehicle operator, the method comprising:
detecting damage to a vehicle with a sensor located within the vehicle;
recording information regarding a condition of the vehicle and an environment surrounding the vehicle with a recording device responsive to damage detected by the sensor;
transmitting a signal to a vehicle operator alerting of the detected damage to the vehicle.

10. The method of communicating a vehicle condition as recited in claim 9, including recording images surrounding the vehicle with at least one camera mounted within the vehicle responsive to detected damage.

11. The method of communicating a vehicle condition as recited in claim 9, including recording vehicle operating conditions responsive to detected damage.

12. The method of communicating a vehicle condition as recited in claim 9, wherein the transmitted signal includes information quantifying the detected damage to the vehicle.

13. The method of communicating a vehicle condition as recited in claim 9, wherein the transmitted signal is sent to emergency service organization responsive to the detected damage meeting predefined criteria indicative of possible injury.

14. The method of communicating a vehicle condition as recited in claim 9, including communicating recorded vehicle operating conditions and surrounding images through a signal to a location outside the vehicle to preserve a record of damage to the vehicle.

15. The method of communicating a vehicle condition as recited in claim 9, including transmitting the signal immediately upon detecting damage to the vehicle.
